(19) United States
(12) Patent Application Publication
(10) Pub. No.: US 2025/0094222 A1
(43) Pub. Date: Mar. 20, 2025

(54) COOLING BASED ON WORKLOAD PRIORITY LEVEL

(71) Applicant: Microsoft Technology Licensing, LLC, Redmond, WA (US)

(72) Inventors: Anant Shankar DEVAL, Redmond, WA (US); Unnikrishnan VADAKKANMARUVEEDU, Chandler, AZ (US); Mohammed A. EL-TANANI, Beaverton, OR (US); Steve Qingjun CAI, Snoqualmie, WA (US)

(21) Appl. No.: 18/468,127

(22) Filed: Sep. 15, 2023

(51) Int. Cl. G06F 9/48

(52) U.S. Cl. CPC G06F 9/4893; G06F 9/4887

(57) ABSTRACT

The described technology provides a method including determining a priority level associated with a workload, determining, based on the priority level associated with the workload, a threshold cooling level of a computing unit implementing the workload, receiving, at a base motherboard controller (BMC) associated with the computing unit implementing the workload, a current temperature of the computing unit implementing the workload, and adjusting, based on the threshold cooling level of the computing unit implementing the workload and the current temperature of the computing unit implementing the workload, a usage level of a cooling system of the computing unit implementing the workload.

### BACKGROUND

With the rapid development of technology and computer applications, servers are increasingly being used in various fields. Currently, a server is provided with a baseboard motherboard controller (BMC), wherein the BMC is an independent embedded device and has an independent power-on time sequence. The BMC may monitor the state of a main board in real time, including current and voltage, temperature, fan rotation speed, rate of coolant flow, and the like. In order to dissipate heat from the chassis, a number of fans may be disposed in the chassis, the rotation speed of the fans is determined by the controller on the BMC.

### SUMMARY

The described technology provides a method including determining a priority level associated with a workload, determining, based on the priority level associated with the workload, a threshold cooling level of a computing unit implementing the workload, receiving, at a base motherboard controller (BMC) associated with the computing unit implementing the workload, a current temperature of the computing unit implementing the workload, and adjusting, based on the threshold cooling level of the computing unit implementing the workload and the current temperature of the computing unit implementing the workload, a usage level of a cooling system of the computing unit implementing the workload.

The above presents a simplified summary of the innovation in order to provide a basic understanding of some implementations described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Other implementations are also described and recited herein.

### BRIEF DESCRIPTIONS OF THE DRAWINGS

Examples are illustrated in referenced figures of the drawings. It is intended that the examples and figures disclosed herein are to be considered illustrative rather than restrictive.

FIG. 1 illustrates an example computing system including a cooling system that is controlled based on workload priority levels.

FIG. 2 illustrates an alternative example implementation of a computing system using a cooling system that is controlled based on workload priority levels.

FIG. 3 illustrates example operations of the cooling system that is controlled based on workload priority levels.

FIG. 4 illustrates alternative example operations of the cooling system that is controlled based on workload priority levels.

FIG. 5 illustrates an example computing system that may be used to implement the cooling management system disclosed herein.

### DETAILED DESCRIPTIONS

Technology disclosed herein relates to controlling speed of the cooling system, such as a fan, used for cooling a blade motherboard having a number of CPUs. Implementations of the technology disclosed herein provide servers on a blade with a baseboard motherboard controller (BMC) that runs fan control speed algorithm. Each of the various CPUs on the blade motherboard may be dedicated to different virtual machines (VMs) where the VMs may be associated with different processes/workloads having different priority levels assigned thereto. The technology disclosed herein uses these priority levels associated with the processes/workloads of the VMs to control the speed of the fan that may be associated with specific CPUs. For example, The BMC may receive the priority level associated with a process on a CPU and the BMC may use the priority level to adjust the speed of the fan associated with the CPU running the process. In one implementation, the priority level may indicate the process hot/process cold, etc., associated with the process running on a specific CPU.

Specific implementations disclosed herein illustrate the BMC receiving process hot signal from the VM indicating that a workload on a CPU is increasing the temperature on a CPU and associated priority level of the workload. In response, the BMC may increase the fan speed associated with the CPU. Furthermore, the BMC may also throttle back one or more process on other CPUs and adjust down the fan speed associated with these other CPUs.

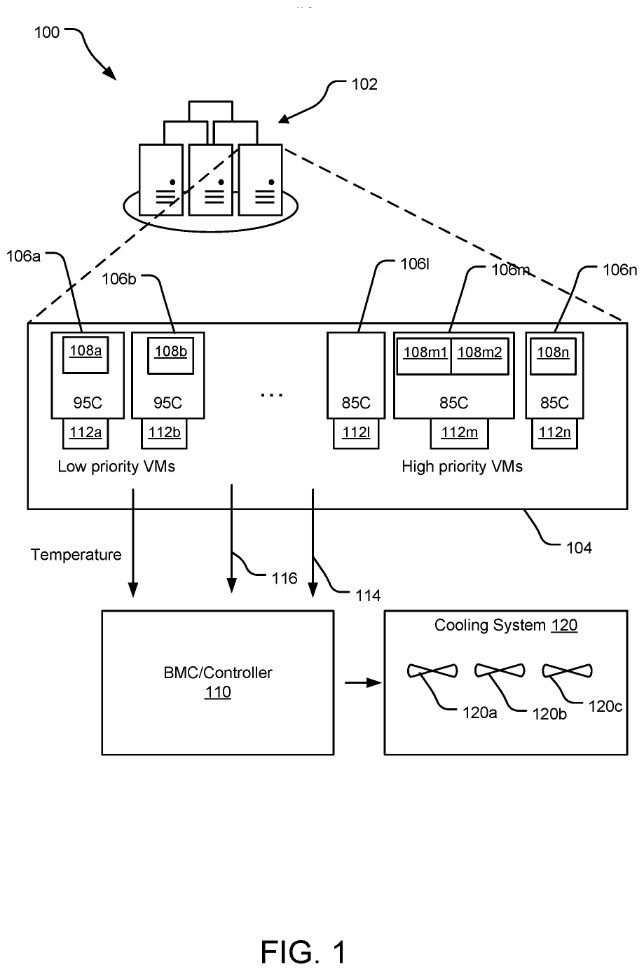

FIG. 1 illustrates a computing system 100 including a cooling system that is controlled based on workload priority levels. Specifically, FIG. 1 illustrates a server 102 implemented on a system on chip (SoC) 104. The SoC 104 may include one or more computing units 106. For example, each of the computing units 106 may include a CPU and its related hardware and firmware. The server 102 may be associated with a number of virtual machines (VMs) with each of the VM allocated to a particular one of the computing units 106. Thus, for example, a VM 108a may be associated with the computing unit 106a, a VM 108b may be associated with the computing unit 108b, VMs 108m1 and 198m2 may be associated with a computing unit 106m, etc., (referred to herein collectively as VMs 108).

In one implementation, each of the VMs 108 may have a priority level associated therewith. For example, the VMs 108a and 108b may be designated to be low priority VMs whereas the VMs 108m1, 108m2 maybe high priority VMs. The priority levels associated with the VMs 108 may be based on a number of different criteria, including the processes or the workloads related to the VMs. For example, the VM 108a may have a workload that is non-production workload and therefore, VM 108a is assigned a low priority. Similarly, the VM 108b may be associated with a non-user facing workload and therefore, VM 108b may also be assigned a low priority as well. On the other hand, the VM 108m1 maybe associated with a user facing workload, a latency critical workload, etc., and therefore, assigned a high priority.

While in the illustrated implementation, there are only two levels of priority levels, specifically low priority and high priority assigned to various VMs, in an alternative implementation, a different number of priority levels may be assigned. For example, the priority levels may be assigned with numeric value between 1 to 10, with a level 10 being the highest priority and the level 1 being the lowest priority. In such an implementation, two VMs associated with a given computing unit may have different priority levels, and the higher of the two priority levels may be considered for making a decision regarding any temperature threshold or cooling level of the computing unit. For example, if the VM 108m1 has a low priority level of 3 and the VM 108m2 has a higher priority level of 9, the higher priority level of 9 may be associated with the computing unit 106m when determining its temperature threshold.

Depending on the processes running on them, each of the computing units 106 may experience a different temperature at any given point during its operation. For example, the VM 108m1 running a user facing process may be more active and therefore generate higher temperature for the computing unit 106m. In the illustrated implementation, based on the priority levels of the VMs 108, each of the computing units 106 may be provided a threshold temperature. Specifically, the temperature thresholds of the computing units 106 maybe inversely related to the priority levels of the VMs. Thus, a computing unit running low priority VM may be allowed to have higher temperature, whereas a computing unit running a high priority VM may be allowed to have a lower temperature.

For example, if the VMs 108a and 108b running on the computing units 106a and 106b are low priority VMs, the computing units 106a and 106b may be provided a threshold temperature of 95 Celsius. On the other hand, if the VM 108n is a high priority VM, the associated computing unit 106n may be provided a threshold temperature of 85 Celsius. In other words, the temperature of the computing units running low priority VMs are allowed to get hotter compared to the allowed maximum temperature of the computing units running high priority VMs.

The SoC 104 may also include a controller 110 that controls various operations of the SoC 104. For example, the controller 110 may control the power supplied to the various computing units 106, cooling of the various computing units 106, etc. In one implementation, the controller 110 may receive current, voltage, temperature of the computing units 106 on a predetermined time intervals, such as for example at every second, every five seconds, etc. Specifically, one or more temperature sensors 112 associated with the computing units 106 may measure the temperatures on the computing units 106 on periodic basis and send the temperature to the controller 110. In one implementation, the sensors 112 may be configured to send the temperatures of the computing units 106 at predetermined time intervals. Alternatively, the controller 110 may send a request to the sensors at predetermined time intervals or as necessary. If the controller 110 is configured on a motherboard, it may be referred to as a base motherboard controller (BMC). However, if the controller 110 is configured on a SoC, it may also be referred to as a power controller, system controller, etc.

For example, a computing unit 106n may determine that it has received a process running on its VM 108n that is a production critical process and in response, the computing unit 106n may send a process hot signal 114 to the controller 110. In this case, the controller 110 may request the current temperature of the computing unit 106n and compare the current temperature to the temperature threshold of the computing unit 106n to determine if the cooling provided to the computing unit 106n needs to be increased or decreased. Alternatively, the SoC 104 may send an SoC hot signal 116 to the controller 110 to indicate the overall higher current temperature of the SoC 104 and in response, the controller 110 may request current temperature from each of the computing units 106 to determine if there is any change in the level of cooling necessary.

The controller 110 may be configured to control a cooling system 120 that provides cooling to the various components on the SoC 104 including the computing units 106. In one implementation, the cooling system 120 is a fan-based cooling system that uses a number of fans to cool the SoC 104. For example, the cooling system 120 may include three fans with a first fan 120a cooling computing units 106a, 106b, a second fan 120b cooling computing units 106l, 106m, 106n, and a third fan 120c cooling the other components on the SoC 104. In one implementation, the controller 110 determines the speed of the fans and therefore the cooling level provided to the various computing units 106.

Specifically, the controller 110 takes into account the current temperature of the computing units 106 as well as the temperature threshold associated with the computing units 106 to determine the fan speed. For example, the controller 110 may receive the current temperature of the computing unit 106n to be 88 Celsius and compare it to the temperature threshold of 8c Celsius and based on this comparison, increase the speed of the fan 120c so as to provide further cooling to the computing unit 106n running a high priority VM. On the other hand, the controller 110 may receive the current temperature of the computing unit 106a to be at 90 Celsius and based on its comparison to the temperature threshold of 95 Celsius, it may reduce the speed of the fan 120a so as to reduce the amount of cooling provided to the computing unit 106a and therefore conserving energy.

Thus, the illustrated implementation provides a technical benefit by allowing the computing units running high priority VMs to stay at lower temperature so that the high priority workloads, such as latency critical workloads, user-facing workloads, etc., are run more efficiently. On the other hand, the illustrated implementations also reduce the overall power consumption by reducing the usage of the cooling system to reduce the cooling for computing units that are running low priority workloads, such as non-user facing workload, non-production workload, etc.

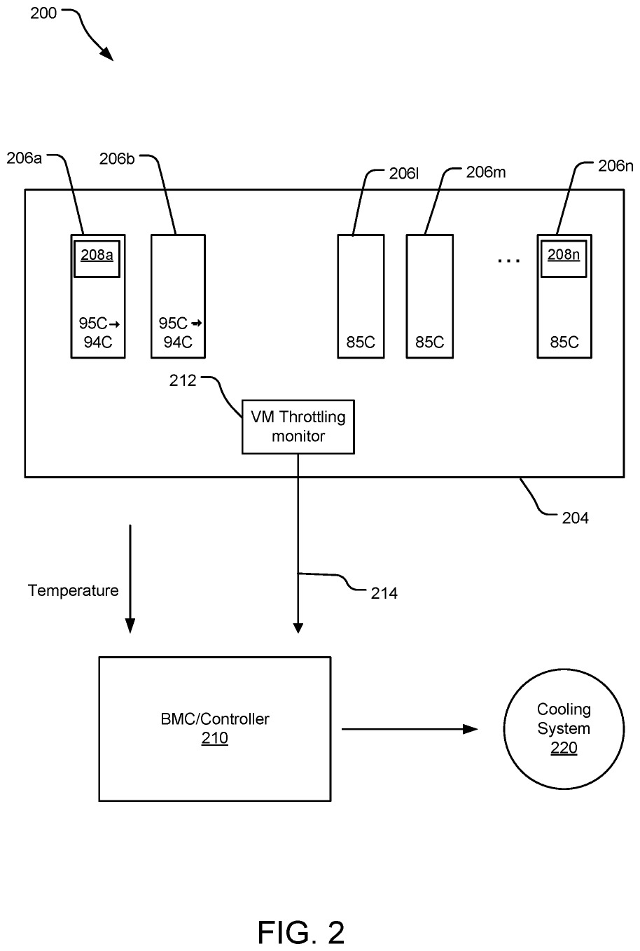

FIG. 2 illustrates an alternative implementation of a computing system 200 using a cooling system that is controlled based on workload priority levels. Specifically, the computing system 200 includes a server implemented on a system on chip (SoC) 204. The SoC 204 may include one or more computing units 206. The server may be associated with a number of virtual machines (VMs) with each of the VM allocated to a particular one of the computing units 206.

The SoC 204 may also include VM throttling monitor 212 that monitors throttling of the VMs running on one or more of the various computing units 206. In one implementation, a controller 210 may control the operating of various components on the SoC 204, including the power provided to the computing units 206, the cooling of the computing units 206, etc. The controller 210 may also control operation of a cooling system 220. In one implementation, the controller may receive temperatures of the computing units 206 as well as the SoC 204 and in response to the temperatures, it may control the operation of the cooling system 220.

In one implementation, the VM throttling monitor 212 may store throttling residency thresholds for the various VMs running on the computing units 206, where each throttling residency threshold indicates the period of time for which performance VMs with low or medium priority may be throttled. For example, the VM throttling monitor 212 a table with throttling residency thresholds for each VMs running on the computing units 206 and monitor current throttling times for such VMs. For example, VMs with lower priority levels may be associated with higher throttling residency threshold compared to VMs with higher priority levels. As an example, a VM 208a that is not production critical may have a throttling residency threshold of 30 seconds, whereas a VM 208n that is production critical may have a throttling residency threshold of 5 seconds.

The controller 210 may control the operation of the VMs on the computing units 206 based on the temperatures of the computing units 206 and a throttling residency of the VMs running on the computing units 206. For example, if the controller 210 receives the temperature of the computing unit 206a to be at 95 Celsius and if VM throttling monitor 212 indicates that performance of the VM 208a running on the computing unit 208a is throttled over a predetermined time due to the higher temperature, the controller 210 may increase the cooling of the computing unit 206a by controlling the operation of the cooling system 220.

The implementation of the system 200 allows the controller 210 to manage the cooling of the various computing units 206 such that the performance of any of the VMs running thereon is not significantly affected in an adverse manner. Furthermore, allowing the VMs with the lower priority levels to be throttled allows more cooling to be diverted towards the computing units that are running VMs with higher priority levels for longer periods of time.

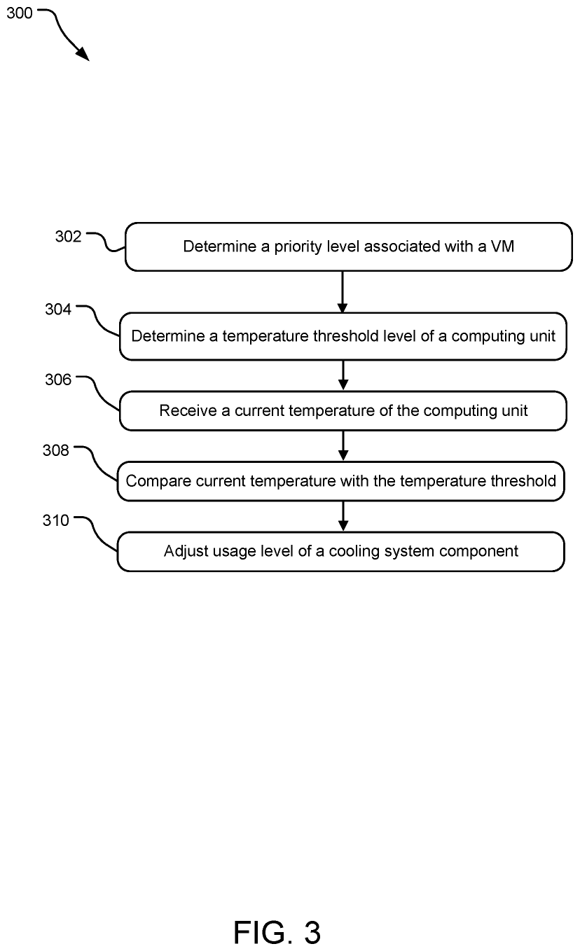

FIG. 3 illustrates operations 300 of the cooling system that is controlled based on VM priority levels. An operation 302 determines a priority level associated with a VM. For example, such priority levels for various VMs may be provided by the computing units on which the VM is running. Such computing units may include hardware, firmware, software, and combination thereof. An operation 304 determines a temperature threshold for the computing unit on which the VM is running. The temperature thresholds for the computing units may be based on the priority levels of the VMs. For example, if a high priority level VM is running on a computing unit, a temperature threshold of that computing unit may be lower compared to a temperature threshold of that computing unit running a lower priority VM.

As an example, the temperature threshold of a computing unit running a user-facing workload may be 85 Celsius whereas the temperature threshold of a computing unit running a non-user facing workload may be 95 Celsius. Providing lower temperature threshold for the computing unit running high priority level VM reduces throttling of the high priority VM. On the other hand, providing higher temperature threshold for the computing unit running low priority level VM reduces the usage of the cooling system and therefore conserves power.

An operation 306 receives the current temperature of the various computing units. The current temperature of the computing units is compared with the temperature thresholds by an operation 308. Subsequently, an operation 310 adjusts the usage level of a cooling system component based on the comparison. For example, if the comparison of the current temperature levels with the temperature thresholds indicates that a computing unit temperature is above its threshold, the speed of a fan cooling that particular computing unit maybe increased.

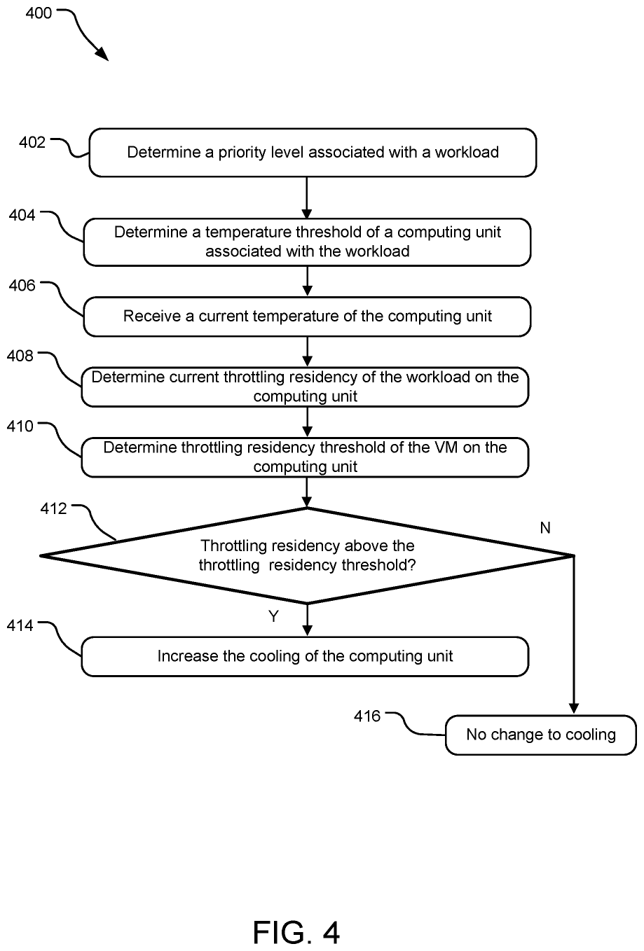

FIG. 4 illustrates alternative operations 400 of the cooling system that is controlled based on workload priority levels. An operation 402 determines a priority level associated with a workload at a computing unit. For example, such workload may be part of a VM that is running on a computing unit. An operation 404 determines a temperature threshold of a computing unit associated with the workload. Specifically, such temperature threshold may be based on the priority level associated with the workload, as determined by the operation 402. Subsequently, an operation 406 receives the current temperature of the computing unit.

In one implementation, even if the temperature thresholds for the workload/VM's of different priorities are the same, the controller may reduce the power consumption of the low priority VM's to keep it within the temperature threshold instead of raising the duty cycle of the fan or flow rate of coolant to conserve energy. The controller may further determine the trade-off between power of the system and performance of the workload based on a policy.

Ab operation 408 may determines a current throttling residency of the workload on the computing unit and an operation 410 may determine a throttling residency threshold of the VM implemented on the computing unit. In one implementation, the throttling residency threshold is determined based on an energy performance preference (EPP) parameter associated with the computing unit implementing the VM. In another implementation, the throttling residency threshold and the current throttling residency may be determined by a VM throttling monitor. An operation 412 compares the throttling residency threshold and the throttling residency and if the current throttling residency is above the throttling residency threshold, an operation 414 increases the cooling of the computing unit. On the other hand, if the current throttling residency is below the throttling residency threshold, no change in cooling is required as per operation 416.

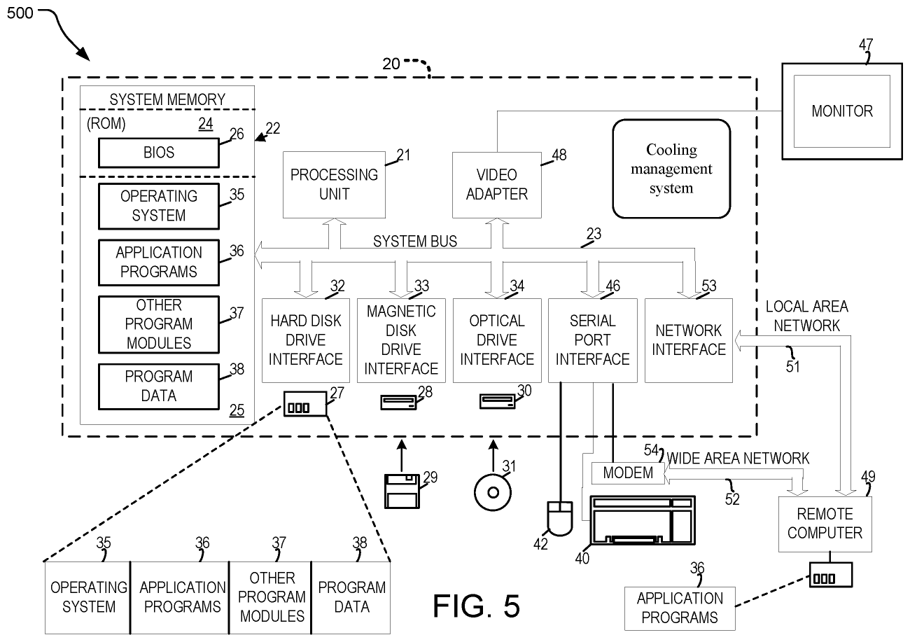

FIG. 5 illustrates an example system 500 that may be useful in implementing the cooling management disclosed herein. The example hardware and operating environment of FIG. 5 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 5, for example, the computer 20 includes a processing unit 21, a system memory 22, and a system bus 23 that operatively couples various system components including the system memory 22 to the processing unit 21. There may be only one or there may be more than one processing unit 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

In the example implementation of the computing system 1200, the computer 20 also includes a cooling management system 510 disclosed herein.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read-only memory (ROM) 24 and random-access memory (RAM). A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

In one implementation, one or more instructions to interpret signal outputs generated by the cooling management system 510 may be stored in the memory of the computer 20, such as the read-only memory (ROM) 24 and random-access memory (RAM) 25, etc.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 12 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the cooling management system 510 may be stored in system memory 22 and/or storage devices 29 or 31 and processed by the processing unit 21. The cooling management system 510 and data used by the cooling management system 510 may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared, and other wireless media.

Some implementations of the cooling management system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The differential capacitance sensing system disclosed herein may include a variety of tangible computer-readable storage media and intangible computer-readable communication signals. Tangible computer-readable storage can be embodied by any available media that can be accessed by the cooling management system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the cooling management system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared, and other wireless media.

Implementations disclosed herein disclose a method including determining a priority level associated with a workload, determining, based on the priority level associated with the workload, a threshold cooling level of a computing unit implementing the workload, receiving, a current temperature of the computing unit implementing the workload, and adjusting, based on the threshold cooling level of the computing unit implementing the workload and the current temperature of the computing unit implementing the workload, a usage level of a cooling system cooling the computing unit implementing the workload.

An alternative implementation discloses a computing system including a memory, one or more processor units, a cooling system, and a cooling management system stored in the memory and executable by the one or more processor units, the cache coherence system encoding computer-executable instructions on the memory for executing on the one or more processor units a computer process, the computer process including determining a priority level associated with a virtual machine (VM), determining, based on the priority level associated with the VM, a threshold cooling level of a computing unit implementing the VM, receiving, at a base controller associated with the computing unit implementing the VM, a current temperature of the computing unit implementing the VM, and adjusting, based on the threshold cooling level of the computing unit implementing the VM and the current temperature of the computing unit implementing the VM, a usage level of the cooling system cooling the computing unit implementing the VM.

Another implementation discloses a physical article of manufacture including one or more tangible computer-readable storage device, encoding computer-executable instructions for executing on a computer system a computer process, the computer process including determining a priority level associated with a virtual machine (VM), determining, based on the priority level associated with the VM, a threshold cooling level of a computing unit implementing the VM, receiving, at a base controller associated with the computing unit implementing the VM, a current temperature of the computing unit implementing the VM, and adjusting, based on the threshold cooling level of the computing unit implementing the VM and the current temperature of the computing unit implementing the VM, a usage level of the cooling system cooling the computing unit implementing the VM.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

What is claimed is:

1. A method comprising:
determining a priority level associated with a workload;
determining, based on the priority level associated with the workload, a threshold cooling level of a computing unit implementing the workload;
receiving, a current temperature of the computing unit implementing the workload; and
adjusting, based on the threshold cooling level of the computing unit implementing the workload and the current temperature of the computing unit implementing the workload, a usage level of a cooling system cooling the computing unit implementing the workload.

2. The method of claim 1, wherein the threshold cooling level of a computing unit implementing a high priority workload is lower than a threshold cooling level of a computing unit implementing a low priority workload.

3. The method of claim 1, wherein determining a priority level associated with the workload further comprising:
receiving the workload at a virtual machine (VM);
determining a priority level of the workload; and
determining the priority level associated with the VM based on the priority level of the workload.

4. The method of claim 3, wherein determining a priority level of the workload further comprising:
determining the workload type as being one of a production workload and a non-production workload; and
assigning a higher priority level to a production workload compared to a priority level assigned to a non-production workload.

5. The method of claim 3, wherein determining a priority level of the workload further comprising:
determining the workload type as being one of a latency-critical workload and a non-latency-critical workload; and
assigning a higher priority level to a latency-critical workload compared to a priority level assigned to a non-latency-critical workload.

6. The method of claim 1 further comprising:
determining a throttling residency of a workload at the computing unit implementing the workload;
comparing the throttling residency with a throttling residency threshold of the workload; and
in response to determining that throttling residency of the workload at the computing unit implementing the workload is above the throttling residency threshold of the workload, increasing the cooling of the computing unit implementing the workload.

7. The method of claim 6 wherein the throttling residency threshold of the VM is based on a priority level of the workload.

8. The method of claim 6, wherein the throttling residency threshold of the VM is based on an energy performance preference (EPP) parameter associated with the computing unit implementing the workload.

9. The method of claim 1, wherein the cooling system includes at least one cooling fans configured to cool the computing unit implementing the workload.

10. A computing system, comprising:
memory;
one or more processor units;
a cooling system; and
a cooling management system stored in the memory and executable by the one or more processor units, the cache coherence system encoding computer-executable instructions on the memory for executing on the one or more processor units a computer process, the computer process comprising:
determining a priority level associated with a virtual machine (VM);
determining, based on the priority level associated with the VM, a threshold cooling level of a computing unit implementing the VM;
receiving, at a base controller associated with the computing unit implementing the VM, a current temperature of the computing unit implementing the VM; and
adjusting, based on the threshold cooling level of the computing unit implementing the VM and the current temperature of the computing unit implementing the VM, a usage level of the cooling system cooling the computing unit implementing the VM.

11. The computing system of claim 10, wherein determining a priority level associated with the VM further comprising:
receiving a workload of the VM;
determining a priority level of the workload; and
determining the priority level associated with the VM based on the priority level of the workload.

12. The computing system of claim 11, wherein determining a priority level of the workload further comprising:
determining the workload type as being one of a production workload and a non-production workload; and
assigning a higher priority level to a production workload compared to a priority level assigned to a non-production workload.

13. The computing system of claim 11, wherein determining a priority level of the workload further comprising:
determining the workload type as being one of a latency-critical workload and a non-latency-critical workload; and
assigning a higher priority level to a latency-critical workload compared to a priority level assigned to a non-latency-critical workload.

14. The computing system of claim 10, wherein the computer process further comprising:
determining a throttling residency of a workload at the computing unit implementing the VM;
comparing the throttling residency with a throttling residency threshold of the VM; and
in response to determining that throttling residency of the workload at the computing unit implementing the VM is above the throttling residency threshold of the VM, increasing the cooling of the computing unit implementing the VM.

15. A physical article of manufacture including one or more tangible computer-readable storage device, encoding computer-executable instructions for executing on a computer system a computer process, the computer process comprising:
determining a priority level associated with a virtual machine (VM);
determining, based on the priority level associated with the VM, a threshold cooling level of a computing unit implementing the VM;
receiving, at a base motherboard controller (BMC) associated with the computing unit implementing the VM, a current temperature of the computing unit implementing the VM; and
adjusting, based on the threshold cooling level of the computing unit implementing the VM and the current temperature of the computing unit implementing the VM, a usage level of a cooling system cooling the computing unit implementing the VM.

16. The physical article of manufacture of claim 15, wherein determining a priority level associated with the VM further comprising:
receiving a workload of the VM;
determining a priority level of the workload; and
determining the priority level associated with the VM based on the priority level of the workload.

17. The physical article of manufacture of claim 15, wherein determining a priority level of the workload further comprising:
determining the workload type as being one of a production workload and a non-production workload; and
assigning a higher priority level to a production workload compared to a priority level assigned to a non-production workload.

18. The physical article of manufacture of claim 15, wherein determining a priority level of the workload further comprising:
determining the workload type as being one of a latency-critical workload and a non-latency-critical workload; and
assigning a higher priority level to a latency-critical workload compared to a priority level assigned to a non-latency-critical workload.

19. The physical article of manufacture of claim 15, wherein the computer process further comprising:
determining a throttling residency of a workload at the computing unit implementing the VM;
comparing the throttling residency with a throttling residency threshold of the VM; and
in response to determining that throttling residency of the workload at the computing unit implementing the VM is above the throttling residency threshold of the VM, increasing the cooling of the computing unit implementing the VM.

20. The physical article of manufacture of claim 15, wherein the throttling residency threshold of the VM is based on a priority level of the VM.
